(19) United States
(12) Patent Application Publication
(10) Pub. No.: US 2025/0043060 A1
(43) Pub. Date: Feb. 6, 2025

(54) MULTIFUNCTIONAL BIOBASED WATERBORNE POLYURETHANE COMPOSITION CONTAINING LIGNIN AND METHOD FOR PRODUCING BIOBASED WATERBORNE POLYURETHANE INCLUDING THE SAME

(71) Applicant: KYUNGPOOK NATIONAL UNIVERSITY INDUSTRY-ACADEMIC COOPERATION FOUNDATION, Daegu (KR)

(72) Inventors: Jaehyeung PARK, Daegu (KR); Bo Min KIM, Daegu (KR); Hye Ji PARK, Busan (KR); Gyu Hwan KIM, Daegu (KR); Sun Jin JANG, Daegu (KR); Jae Hyeon PARK, Daegu (KR)

(73) Assignee: KYUNGPOOK NATIONAL UNIVERSITY INDUSTRY-ACADEMIC COOPERATION FOUNDATION, Daegu (KR)

(21) Appl. No.: 18/675,255

(22) Filed: May 28, 2024

(30) Foreign Application Priority Data
Aug. 4, 2023 (KR) 10-2023-0102131

(51) Int. Cl. C08G 18/64

(52) U.S. Cl. CPC C08G 18/64

(57) ABSTRACT

A multifunctional biobased waterborne polyurethane composition includes, based on 100 parts by weight of the polyurethane composition, 40 to 50 parts by weight of a polyol, 34 to 42 parts by weight of an isocyanate, 8 to 14 parts by weight of a chain extender, 0.03 to 0.12 parts by weight of a catalyst, and 0.005 to 0.02 parts by weight of a neutralizing agent.

### CROSS-REFERENCE TO PRIOR APPLICATION

This application claims priority to Korean Patent Application No. 10-2023-0102131 (filed on Aug. 4, 2023), which is hereby incorporated by reference in its entirety.

### BACKGROUND

The present disclosure relates to a multifunctional biobased waterborne polyurethane composition containing lignin and a method for producing a biobased waterborne polyurethane including the same, and more specifically, to a multifunctional biobased waterborne polyurethane composition having various functionalities, such as antibacterial activity, UV protection properties, and improved mechanical properties, due to high intermolecular interactions between lignin molecules and urethane molecules as a result of adding lignin to biobased waterborne polyurethane, and a method for producing a biobased waterborne polyurethane including the same.

Due to the global problem of depletion of petroleum resources and the problem of environmental pollution caused by carbon dioxide generated when using petroleum resources, there has been increasing interest in the use of biomass, which may be used continuously and developed as an alternative to petroleum and is environmentally friendly. Following this trend, studies have been actively conducted to convert lignocellulosic biomass into bioethanol and chemical materials.

Lignin, a representative lignocellulosic biomass, is an amorphous material having an aromatic structure and is the second most abundant natural polymer material after cellulose. Lignin has a very high specific energy content compared to cellulose and is rich in renewable natural aromatics.

Polyurethane is a polymer material that may be widely used in various fields such as furniture and building fields. By replacing polyols and isocyanates, which are the raw materials of polyurethanes, with lignin, it is possible to reduce dependence on petroleum and produce environmentally friendly polyurethanes.

In particular, the production of bio-polyurethanes having various functionalities by the addition of lignin is a field that is attracting attention in the polyurethane industry. However, the method of producing polyurethane by adding lignin as described above has limitations in that a large amount of organic solvent is used during production and mechanical properties are poor.

Due to the above limitations, there is a need for a method for producing polyurethane that may provide functionality by adding lignin, use a reduced amount of organic solvent during production, and improve mechanical properties.

### SUMMARY

An object of the present disclosure is to solve the above-described problems and to provide a multifunctional biobased waterborne polyurethane composition containing lignin, which has functionalities such as UV protection properties and antibacterial activity, as well as improved mechanical properties, and a method for producing a biobased waterborne polyurethane including the same.

Another object of the present disclosure is to provide a biobased waterborne polyurethane composition containing lignin, which is produced using a reduced amount of organic solvent and contains an environmentally friendly bio-base, and a method for producing a biobased waterborne polyurethane including the same.

Objects to be achieved by the present disclosure are not limited to the objects mentioned above, and other objects not mentioned above will be clearly understood by those skilled in the art from the description of the present disclosure.

To achieve the above objects, the present disclosure provides a multifunctional biobased waterborne polyurethane composition containing lignin and a method for producing a biobased waterborne polyurethane including the same.

The present disclosure provides a multifunctional biobased waterborne polyurethane composition including, based on 100 parts by weight of the polyurethane composition, 40 to 50 parts by weight of a polyol, 34 to 42 parts by weight of an isocyanate, 8 to 14 parts by weight of a chain extender, 0.03 to 0.12 parts by weight of a catalyst, and 0.005 to 0.02 parts by weight of a neutralizing agent.

In the present disclosure, the polyurethane composition may further include 1 to 10 parts by weight of lignin.

In the present disclosure, the polyurethane composition may include the isocyanate, the polyol and the chain extender at a molar ratio of 1:2.3 to 2.7:0.4 to 0.8.

In the present disclosure, the polyol may be any one or more selected from the group consisting of a bio-polyol and a polyol, wherein the bio-polyol may be any one or more selected from the group consisting of castor oil, soybean oil, canola oil, peanut oil, coconut oil, sunflower oil, and cashew nut shell liquid, and the polyol may be any one or more selected from the group consisting of aliphatic polyester polyol, polyether polyol, aromatic polyester polyol, polyethylene glycol, and phenolic polyol.

In the present disclosure, the isocyanate may be any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI), the chain extender may be any one or more selected from the group consisting of N-methyldiethanolamine (MDEA) and diethylamine (DEA), the catalyst may be any one or more selected from the group consisting of dibutyltin dilaurate (DBTDL), dimethyl hydroxy tin oleate, and dibutyltin maleate, and the neutralizing agent may be any one or more selected from the group consisting of acetic acid, formic acid, and propionic acid.

The present disclosure also provides a method for producing multifunctional biobased waterborne polyurethane, comprising steps of: producing a first reaction solution by adding an isocyanate and a first chain extender to a reaction solvent, followed by reaction at 40 to 60° C. for 40 to 80 minutes; producing a second reaction solution by adding a polyol to the first reaction solution, followed by reaction at a temperature of 55 to 75° C. for 20 to 40 minutes; producing a third reaction solution by adding a reaction catalyst to the second reaction solution, followed by reaction for 40 to 80 minutes; producing a fourth reaction solution by adding a second chain extender to the third reaction solution, followed by chain extension reaction for 2 to 4 hours; cooling the fourth reaction solution to a room temperature, followed by neutralization with neutralizing agent; adding an aqueous lignin solution to the neutralized solution with stirring; emulsifying the stirred solution by dispersion for 10 to 14 hours; evaporating the solvent from the emulsified solution; and collecting polyurethane as a final product.

In the present disclosure, the step of adding the aqueous lignin solution may include adding lignin in an amount of 1 to 10 parts by weight based on 100 parts by weight of the polyurethane.

In the present disclosure, the method for producing waterborne polyurethane may include adding, based on 100 parts by weight of the polyurethane, 40 to 50 parts by weight of the polyol, 1 to 10 parts by weight of the lignin, 34 to 42 parts by weight of the isocyanate, 8 to 14 parts by weight of the chain extender, 0.03 to 0.12 parts by weight of the catalyst, and 0.005 to 0.02 parts by weight of the neutralizing agent.

In the present disclosure, the method for producing polyurethane may include adding the isocyanate, the polyol and the chain extender at a molar ratio of 1:2.3 to 2.7:0.4 to 0.8.

In the present disclosure, the polyol may be any one or more selected from the group consisting of a bio-polyol and a polyol, wherein the bio-polyol may be any one or more selected from the group consisting of castor oil, soybean oil, canola oil, peanut oil, coconut oil, sunflower oil, and cashew nut shell liquid, and the polyol may be any one or more selected from the group consisting of aliphatic polyester polyol, polyether polyol, aromatic polyester polyol, polyethylene glycol, and phenolic polyol.

In the present disclosure, the isocyanate may be any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI), the chain extender may be any one or more selected from the group consisting of N-methyldiethanolamine (MDEA) and diethylamine (DEA), the catalyst may be any one or more selected from the group consisting of dibutyltin dilaurate (DBTDL), dimethyl hydroxy tin oleate, and dibutyltin maleate, and the neutralizing agent may be any one or more selected from the group consisting of acetic acid, formic acid, and propionic acid.

In the present disclosure, the waterborne polyurethane produced according to the above method may have a glass transition temperature (Tg) of 20 to 35° C.

In the present disclosure, the waterborne polyurethane produced according to the above method may have a full width at half maximum (FWHM) at 20 of 6.58 to 6.85°.

In the present disclosure, the waterborne polyurethane produced according to the above method may have resistance to ethanol.

As described above, the present disclosure may provide a multifunctional biobased waterborne polyurethane composition containing lignin, which has functionalities such as UV protection properties and antibacterial activity, as well as improved mechanical properties, and a method for producing a biobased waterborne polyurethane including the same.

The present disclosure may also provide a biobased waterborne polyurethane composition containing lignin, which is produced using a reduced amount of organic solvent and contains an environmentally friendly bio-base, and a method for producing a biobased waterborne polyurethane including the same.

The present disclosure may also provide a biobased waterborne polyurethane composition that exhibits antibacterial activity against bacteria such as Staphylococcus aureus and Escherichia coli, and a method for producing a biobased waterborne polyurethane including the same.

The present disclosure may also provide a waterborne polyurethane composition that exhibits biobased various functionalities such as high dispersibility, transparency, improved mechanical properties, and UV protection properties dye to the interaction between lignin molecules and urethane molecules, and a method for producing a biobased waterborne polyurethane including the same.

The present disclosure may also provide a multifunctional biobased waterborne polyurethane composition that may be used in a wide range of applications, including packaging materials for food, medicine, and cosmetics, medical materials such as wound dressings, industrial films, external packaging materials for solar cells, building materials, and external packaging materials for automobiles, and a method for producing a biobased waterborne polyurethane including the same.

Effects of the present disclosure are not limited to the effects mentioned above, and other effects not mentioned above may be clearly understood by those skilled in the art from the claims.

### BRIEF DESCRIPTION OF THE DRAWINGS

FIG. 1 shows a mechanism for synthesizing a multifunctional biobased waterborne polyurethane containing lignin according to the present disclosure.

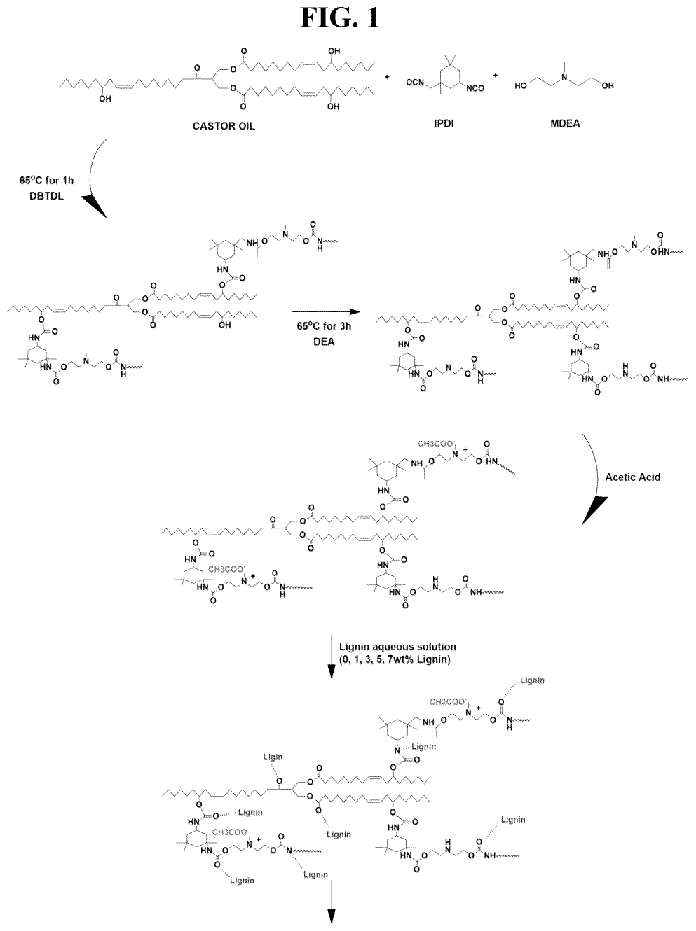

FIG. 2 shows a multifunctional biobased waterborne polyurethane composition containing lignin according to the present disclosure.

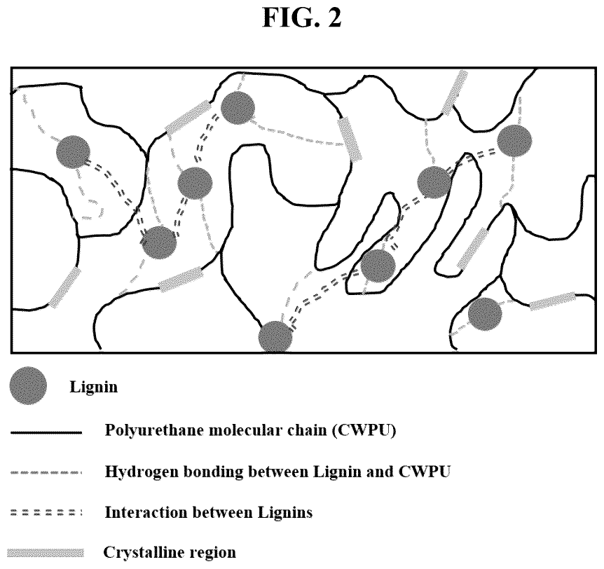

FIG. 3 shows lignin-containing biobased polyurethane films of CWPU-L0, CWPU-L1, CWPU-L3, CWPU-L5 and CWPU-L7 according to the present disclosure.

FIG. 4 shows the results of SEM-EDS of CWPU-L0, CWPU-L1, CWPU-L3, CWPU-L5 and CWPU-L7 according to the present disclosure.

FIG. 5 shows the results of FT-IR analysis of CWPU-L0, CWPU-L1, CWPU-L3, CWPU-L5 and CWPU-L7 according to the present disclosure.

FIG. 6 shows the TGA curves (a), DMA curves (b) and thermal characteristic analysis results (c) of CWPU-L0, CWPU-L1, CWPU-L3, CWPU-L5 and CWPU-L7 according to the present disclosure.

FIG. 7 shows the XRD peak of lignin (a), the XRD peaks of CWPU-L0, CWPU-L1, CWPU-L3, CWPU-L5 and CWPU-L7 (b), and the FWHM of the XRD peaks (c), according to the present disclosure.

FIG. 8 shows CWPU-L0, CWPU-L1, CWPU-L3, CWPU-L5 and CWPU-L7 immediately after immersion in ethanol (a) and 10 hours after immersion in ethanol (b), according to the present disclosure.

FIG. 9 shows the strain-stress curves (a) and mechanical properties (b) of CWPU-L0, CWPU-L1, CWPU-L3, CWPU-L5 and CWPU-L7 according to the present disclosure.

FIG. 10 shows the results of UV/Vis analysis of CWPU-L0, CWPU-L1, CWPU-L3, CWPU-L5 and CWPU-L7 according to the present disclosure.

FIG. 11 shows the antibacterial test results of CWPU-L0, CWPU-L1, CWPU-L3, CWPU-L5 and CWPU-L7 according to the present disclosure.

### DETAILED DESCRIPTION

The terms used in the present specification are currently widely used general terms selected in consideration of their functions in the present disclosure, but they may change depending on the intents of those skilled in the art, precedents, or the advents of new technology. Additionally, in certain cases, there may be terms arbitrarily selected by the applicant, and in this case, their meanings are described in a corresponding description part of the present disclosure. Accordingly, terms used in the present disclosure should be defined based on the meaning of the term and the entire contents of the present disclosure, rather than the simple term name.

Unless otherwise defined, all terms used herein, including technical or scientific terms, have the same meanings as understood by those skilled in the art to which the present disclosure pertains. Terms such as those used in general and defined in dictionaries should be interpreted as having meanings identical to those specified in the context of related technology. Unless definitely defined in the present application, the terms should not be interpreted as having ideal or excessively formative meanings.

A numerical range includes numerical values defined in the range. Every maximum numerical limitation given throughout the present specification includes every lower numerical limitation, as if such lower numerical limitations were expressly written herein. Every minimum numerical limitation given throughout the present specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Multifunctional Biobased Waterborne Polyurethane Composition Containing Lignin

The present disclosure relates to a multifunctional biobased waterborne polyurethane composition containing lignin.

The present disclosure relates to a multifunctional biobased waterborne polyurethane composition including, based on 100 parts by weight of the polyurethane composition, 40 to 50 parts by weight of a polyol, 34 to 42 parts by weight of an isocyanate, 8 to 14 parts by weight of a chain extender, 0.03 to 0.12 parts by weight of a catalyst, and 0.005 to 0.02 parts by weight of a neutralizing agent.

In the present disclosure, the polyurethane composition may further include 1 to 10 parts by weight of lignin. The lignin is preferably included in an amount of 5 to 8 parts by weight. If the lignin is included in an amount of more than 10 parts by weight, a problem may arise in that the dispersion force decreases and thus a polyurethane including the composition is not produced. If the lignin is included in an amount of less than 1 part by weight, the composition may exhibit no antibacterial activity.

If the isocyanate is included in an amount of less than 34 parts by weight, a problem may arise in that the composition may exhibit physical properties unsuitable for use as industrial films, packaging materials, etc., and if the isocyanate is included in an amount of more than 42 parts by weight, a problem may arise in that the produced polyurethane has reduced flexibility.

If the chain extender is included in an amount of less than 8 parts by weight, a problem may arise in that polyurethane is not produced due to lack of hard segments. If the chain extender is included in an amount of more than 14 parts by weight, a problem may arise in that polyurethane (PU) has reduced due to an excessive amount of hard segments.

If the catalyst is included in an amount of less than 0.03 parts by weight, a problem may arise in that the acid value of the bio-polyol rapidly increases, resulting in deterioration in the physical properties of the produced polyurethane. If the catalyst is included in an amount of more than 0.12 parts by weight, a problem may occur in that the conversion rate of biomass is drastically reduced.

If the neutralizing agent is included in an amount of more than 0.02 parts by weight, a problem may occur in that the conversion rate of biomass is drastically reduced.

When polyurethane including the above composition is synthesized, the amount of organic solvent used may be 40 to 60% smaller than that in a conventional synthesis process.

In addition, when polyurethane including the above composition is synthesized, it contains lignin, and thus may exhibit functionalities such as solvent resistance, thermal stability, high dispersibility, transparency, antibacterial activity, UV protection properties, and improved mechanical properties, due to the interaction between lignin molecules and urethane molecules.

In the present disclosure, the polyurethane composition may include the isocyanate, the polyol and the chain extender at a molar ratio of 1:2.3 to 2.7:0.4 to 0.8, preferably 1:2.5:0.6.

The polyol may be any one or more selected from the group consisting of a bio-polyol and a polyol, wherein the bio-polyol may be any one or more selected from the group consisting of castor oil, soybean oil, canola oil, peanut oil, coconut oil, sunflower oil, and cashew nut shell liquid, and the polyol may be any one or more selected from the group consisting of aliphatic polyester polyol, polyether polyol, aromatic polyester polyol, polyethylene glycol, and phenolic polyol.

In the present disclosure, the isocyanate may be any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI), the chain extender may be any one or more selected from the group consisting of N-methyldiethanolamine (MDEA) and diethylamine (DEA), the catalyst may be any one or more selected from the group consisting of dibutyltin dilaurate (DBTDL), dimethyl hydroxy tin oleate, and dibutyltin maleate, and the neutralizing agent may be any one or more selected from the group consisting of acetic acid, formic acid, and propionic acid.

Preferably, the composition may include castor oil as the bio-polyol, isophorone diisocyanate as the isocyanate, N-methyldiethanolamine (MDEA) as the chain extender, dibutyltin dilaurate (DBTDL) as the catalyst, and acetic acid as the neutralizing agent.

### Method for Producing Multifunctional Biobased Waterborne Polyurethane Containing Lignin

The present disclosure relates to a method for producing a multifunctional biobased waterborne polyurethane containing lignin.

The present disclosure relates to a method for producing multifunctional biobased waterborne polyurethane, comprising steps of: producing a first reaction solution by adding an isocyanate and a first chain extender to a reaction solvent, followed by reaction at 40 to 60° C. for 40 to 80 minutes; producing a second reaction solution by adding a polyol to the first reaction solution, followed by reaction at a temperature of 55 to 75° C. for 20 to 40 minutes; producing a third reaction solution by adding a reaction catalyst to the second reaction solution, followed by reaction for 40 to 80 minutes; producing a fourth reaction solution by adding a second chain extender to the third reaction solution, followed by chain extension reaction for 2 to 4 hours; cooling the fourth reaction solution to room temperature, followed by neutralization with a neutralizing agent; adding an aqueous solution to the neutralized solution with stirring; emulsifying the stirred solution by dispersion for 10 to 14 hours; evaporating the solvent from the emulsified solution; and collecting polyurethane as a final product.

In the method for producing multifunctional biobased waterborne polyurethane, the amount of organic solvent used may be 40 to 60% smaller than that in a conventional polyurethane production method.

The production method of the present disclosure differs from the conventional polyurethane production method in the sequence of steps, and due to this difference, the amount of organic solvent required for synthesis may be significantly reduced.

The multifunctional biobased waterborne polyurethane produced according to the above production method contains lignin, and thus may exhibit functionalities such as solvent resistance, thermal stability, high dispersibility, transparency, antibacterial activity, UV protection properties, and improved mechanical properties, due to the interaction between lignin molecules and urethane molecules.

The waterborne polyurethane produced according to the above production method may exhibit high dispersibility and stable UV protection properties due to the interaction between structural features of lignin, such as phenol, ketone and quinoid structures, and biobased waterborne polyurethane molecules.

The waterborne polyurethane produced according to the above production method may exhibit antibacterial activity against Staphylococcus aureus and Escherichia coli.

In the present disclosure, the step of adding the aqueous lignin solution may include adding the lignin in an amount of 1 to 10 parts by weight based on 100 parts by weight of the polyurethane. Preferably, the lignin may be added in an amount of 5 to 8 parts by weight. If the lignin is added in an amount of more than 10 parts by weight, a problem may arise in that the dispersion force decreases and thus a polyurethane including the composition is not produced. If the lignin is added in an amount of less than 1 part by weight, its reaction with the polyol may not occur.

In the present disclosure, the method for producing waterborne polyurethane may include adding, based on 100 parts by weight of the polyurethane composition, 40 to 50 parts by weight of a polyol, 34 to 42 parts by weight of an isocyanate, 8 to 14 parts by weight of a chain extender, 0.03 to 0.12 parts by weight of a catalyst, and 0.005 to 0.02 parts by weight of a neutralizing agent.

In the present disclosure, the polyurethane composition may further include 1 to 10 parts by weight of lignin. The lignin is preferably included in an amount of 5 to 8 parts by weight. If the lignin is included in an amount of more than 10 parts by weight, a problem may arise in that the dispersion force decreases and thus a polyurethane including the composition is not produced. If the lignin is included in an amount of less than 1 part by weight, the composition may exhibit no antibacterial activity.

If the isocyanate is included in an amount of less than 34 parts by weight, a problem may arise in that the composition may exhibit physical properties unsuitable for use as industrial films, packaging materials, etc., and if the isocyanate is included in an amount of more than 42 parts by weight, a problem may arise in that the produced polyurethane has reduced flexibility.

If the chain extender is included in an amount of less than 8 parts by weight, a problem may arise in that polyurethane is not produced due to lack of hard segments. If the chain extender is included in an amount of more than 14 parts by weight, a problem may arise in that polyurethane (PU) has reduced due to an excessive amount of hard segments.

If the catalyst is included in an amount of less than 0.03 parts by weight, a problem may arise in that the acid value of the bio-polyol rapidly increases, resulting in deterioration in the physical properties of the produced polyurethane. If the catalyst is included in an amount of more than 0.12 parts by weight, a problem may occur in that the conversion rate of biomass is drastically reduced.

If the neutralizing agent is included in an amount of more than 0.02 parts by weight, a problem may occur in that the conversion rate of biomass is drastically reduced.

In the present disclosure, the method for producing waterborne polyurethane may include adding the isocyanate, the polyol and the chain extender at a molar ratio of 1:2.3 to 2.7:0.4 to 0.8, preferably 1:2.5:0.6.

In the present disclosure, the polyol may be any one or more selected from the group consisting of a bio-polyol and a polyol, wherein the bio-polyol may be any one or more selected from the group consisting of castor oil, soybean oil, canola oil, peanut oil, coconut oil, sunflower oil, and cashew nut shell liquid, and the polyol may be any one or more selected from the group consisting of aliphatic polyester polyol, polyether polyol, aromatic polyester polyol, polyethylene glycol, and phenolic polyol.

In the present disclosure, the isocyanate may be any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI), the chain extender may be any one or more selected from the group consisting of N-methyldiethanolamine (MDEA) and diethylamine (DEA), the catalyst may be any one or more selected from the group consisting of dibutyltin dilaurate (DBTDL), dimethyl hydroxy tin oleate, and dibutyltin maleate, and the neutralizing agent may be any one or more selected from the group consisting of acetic acid, formic acid, and propionic acid.

Preferably, the composition may include castor oil as the bio-polyol, isophorone diisocyanate as the isocyanate, N-methyldiethanolamine (MDEA) as the chain extender, dibutyltin dilaurate (DBTDL) as the catalyst, and acetic acid as the neutralizing agent.

In the present disclosure, the waterborne polyurethane produced according to the above production method may have a glass transition temperature (Tg) of 20 to 35° C.

In the present disclosure, the waterborne polyurethane produced according to the above production method may have a full width at half maximum (FWHM) at 20 of 6.58 to 6.85°.

In the present disclosure, the waterborne polyurethane produced according to the above production method may have resistance to ethanol.

### Examples

Examples of the present disclosure will be described below in detail, but it is obvious that the present disclosure is not limited to the following examples.

The advantages and features of the present disclosure, and the way of attaining them, will become apparent with reference to the examples described below. However, the present disclosure is not limited to the examples disclosed below and may be embodied in a variety of different forms. Rather, these examples are provided so that this disclosure will be thorough and complete, and will fully convey the scope of the present disclosure to those skilled in the art, and the present disclosure will only be defined by the appended claims

### <Example 1> CWPU-L7

1.031 ml of isophorone diisocyanate (IPDI) as an isocyanate and N-methyldiethanolamine (MEDA) were dissolved in 2 ml of methyl ethyl ketone (MEK) and subjected to a first reaction at 50° C. for 1 hour until the viscosity increased. 4.66 g of castor oil (CO) and 10 ml of methyl ethyl ketone were added to the first reaction solution, and then the temperature was increased to 65° C. and the mixture was subjected to a second reaction for 30 minutes. Thereafter, 80 μL of dibutyltin dilaurate (DBTDL) and 10 ml of methyl ethyl ketone were added to the second reaction solution which was then subjected to a third reaction for 1 hour. 0.142 ml of DEA and 30 ml of methyl ethyl ketone were added to the third reaction solution which was then subjected to a fourth reaction for 3 hours, causing an additional chain extension reaction. Next, the fourth reaction solution was cooled to room temperature, and then 0.725 ml of acetic acid (AA) was added thereto, followed by neutralization for 30 minutes. While the neutralized solution was stirred at 400 rpm, 100 ml of an aqueous lignin solution containing dissolved therein lignin in an amount of 7 parts by weight based on 100 parts by weight of all solid components excluding the solvent was slowly added thereto. The solution containing the lignin added thereto was emulsified by dispersion for 12 hours. Methyl ethyl ketone was removed from the emulsified solution at 70° C. using a rotary evaporator to obtain waterborne polyurethane. The obtained waterborne polyurethane was produced into a film.

### <Example 2> CWPU-L5

CWPU-L5 was produced in the same manner as in Example 1, except that an aqueous lignin solution containing 5 parts by weight of lignin dissolved therein was added.

### <Example 3> CWPU-L3

CWPU-L3 was produced in the same manner as in Example 1, except that an aqueous lignin solution containing 3 parts by weight of lignin dissolved therein was added.

### <Example 4> CWPU-L1

CWPU-L1 was produced in the same manner as in Example 1, except that an aqueous lignin solution containing 1 part by weight of lignin dissolved therein was added.

### <Comparative Example 1> CWPU-L0

CWPU-L0 was produced in the same manner as in Example 1, except that the aqueous lignin solution was not added.

### <Experimental Example 1> Transparency Assessment

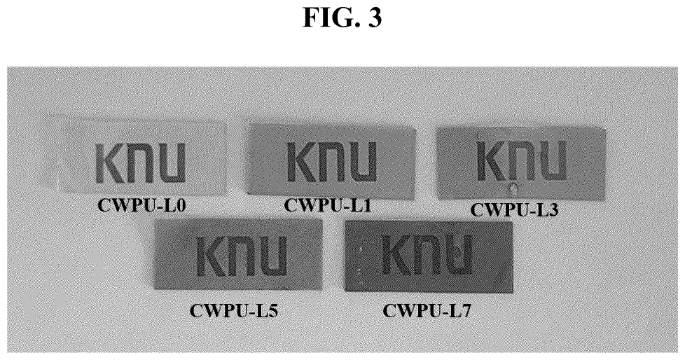

The waterborne polyurethane films produced in Examples 1 to 4 and Comparative Example 1 were photographed with a camera and the photographs are shown in FIG. 3. The transparency of each film was observed with the naked eye.

As shown in FIG. 3, it was confirmed that the films produced in the Examples and the Comparative Example were all transparent, and it was confirmed that the lignin was uniformly dispersed at the molecular level in the films without any agglomeration.

From the above results, it was confirmed that the lignin was uniformly dispersed in the biobased waterborne polyurethane containing lignin, produced according to the present disclosure.

### <Experimental Example 2> SEM-EDS Analysis

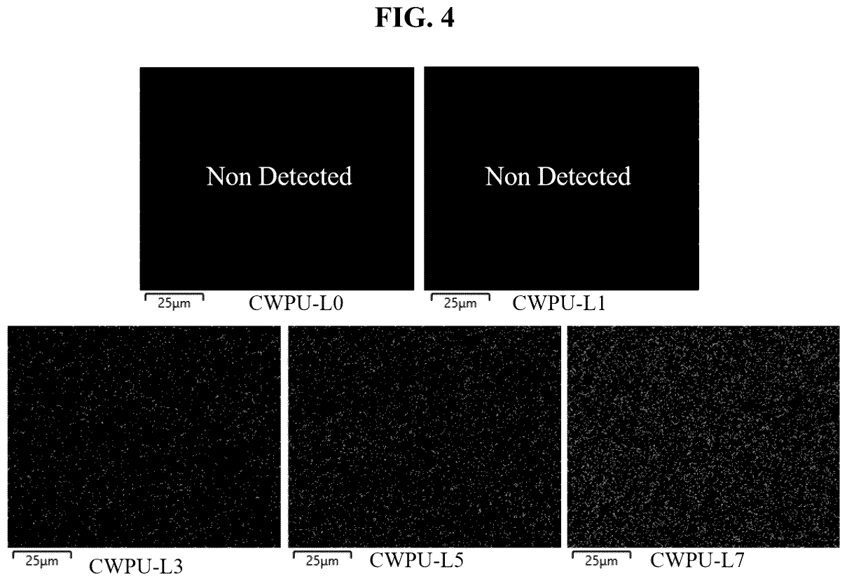

SEM-EDS analysis of the waterborne polyurethane films produced in Examples 1 to 4 and Comparative Example 1 was performed, and the results are shown in FIG. 4.

As shown in FIG. 4, it was confirmed that red dots representing lignin molecules were uniformly dispersed in the films produced in Examples 1 to 3, except for CWPU-L0 of Comparative Example 1, which contains no lignin, and CWPU-L1 of Example 4, which contains a very small amount (1 part by weight) of lignin.

From the above results, it was confirmed that lignin was uniformly dispersed in the biobased waterborne polyurethane containing lignin, produced according to the present disclosure.

### <Experimental Example 3> FT-IR Analysis

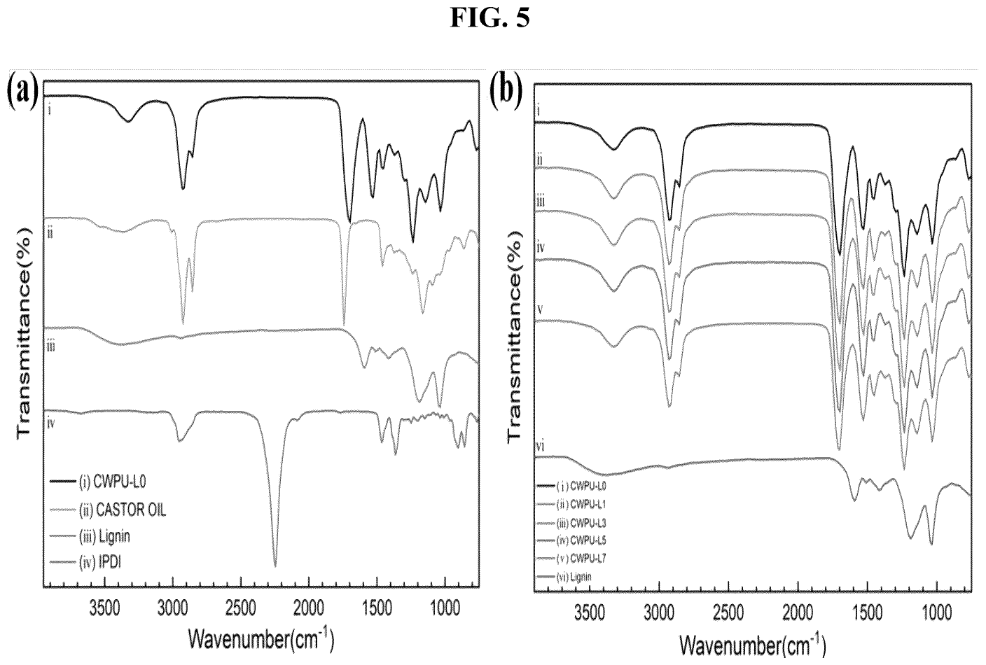

Fourier transform infrared (FT-IR) analysis of the waterborne polyurethane films produced in Examples 1 to 4 and Comparative Example 1 was performed, and the results are shown in FIG. 5(b).

In addition, FT-IR analysis was performed on castor oil and lignin, which are included in the compositions of the waterborne polyurethane films, and CWPU-L0 produced in Comparative Example 1, and the results are shown in FIG. 5(a).

As shown in FIG. 5(b), the diisocyanate (IPDI) peak at 2200 cm⁻¹ shown in FIG. 5(a) did not appear in all of the waterborne polyurethane films produced in the Examples and the Comparative Example.

In addition, the urethane bond peaks at 1697 cm⁻¹ and 1234 cm⁻¹ appeared in all of the waterborne polyurethane films produced in the Examples and the Comparative Example.

From the above results, it was confirmed that the biobased waterborne polyurethane containing lignin, produced according to the present disclosure, exhibited bonding and interactions between lignin molecules and urethane molecules.

### <Experimental Example 4> TGA Analysis

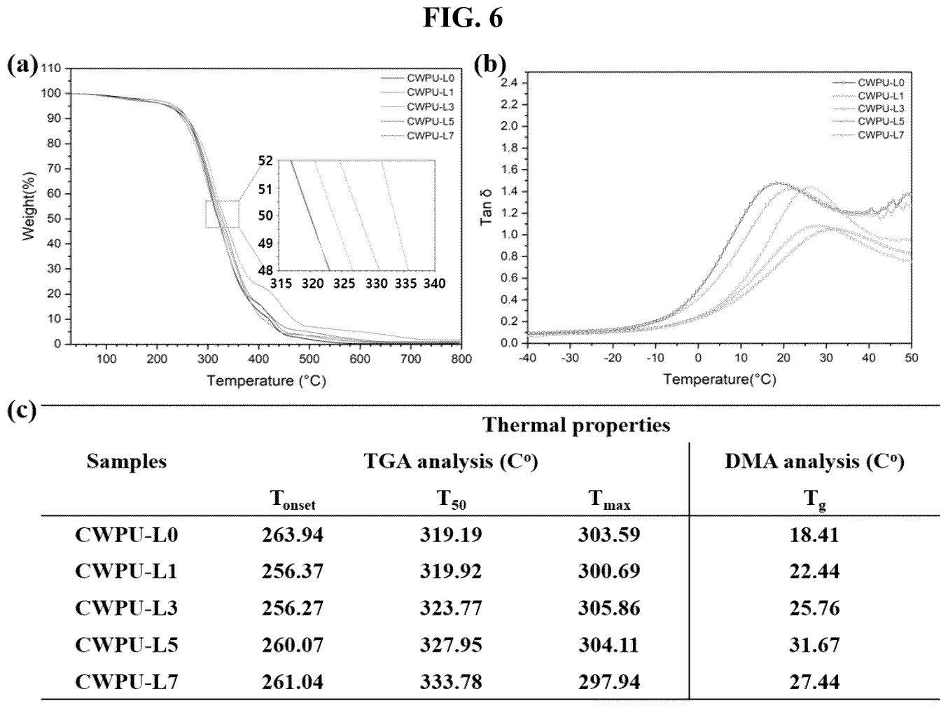

TGA analysis was performed on the waterborne polyurethane films produced in Examples 1 to 4 and Comparative Example 1, and the results are shown in FIG. 6.

As shown in FIG. 6(a), it was confirmed that, as the lignin content increased, the T50 value indicating the thermal properties of the film increased.

In addition, as shown in FIG. 6(c), it was confirmed that Tg, which can be determined through DMA, also increased as the lignin content increased.

From the above results, it was confirmed that the biobased waterborne polyurethane containing lignin, produced according to the present disclosure, had improved thermal stability due to the crosslinking and interaction between lignin and polyurethane, and as the lignin content increased, the crosslinking density increased, indicating high thermal stability.

### <Experimental Example 5> XRD Analysis

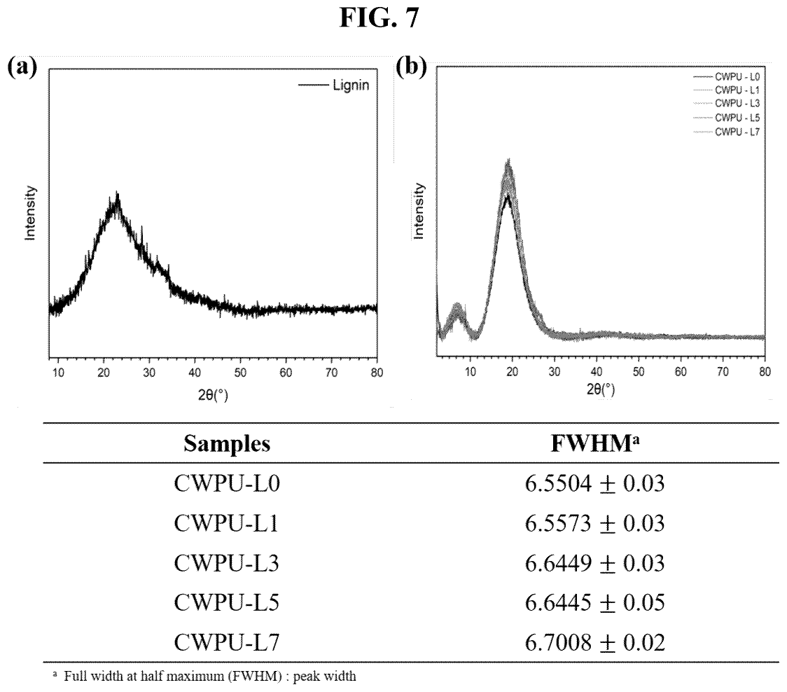

XRD analysis was performed on the waterborne polyurethane films produced in Examples 1 to 4 and Comparative Example 1, and the results are shown in FIG. 7.

As shown in FIG. 7(b), a very narrow XRD peak compared to the XRD peak in FIG. 7(a) appeared in the waterborne polyurethane films produced in Examples 1 to 4 and Comparative Example 1. However, as the lignin content increased, the full width at half maximum (FWHM) at 2θ (°) increased.

From the above results, it was confirmed that the amorphous regions of the biobased waterborne polyurethane containing lignin, produced according to the present disclosure, are regularly arranged due to the interaction between urethane molecular chains and lignin.

### <Experimental Example 6> Swelling Test

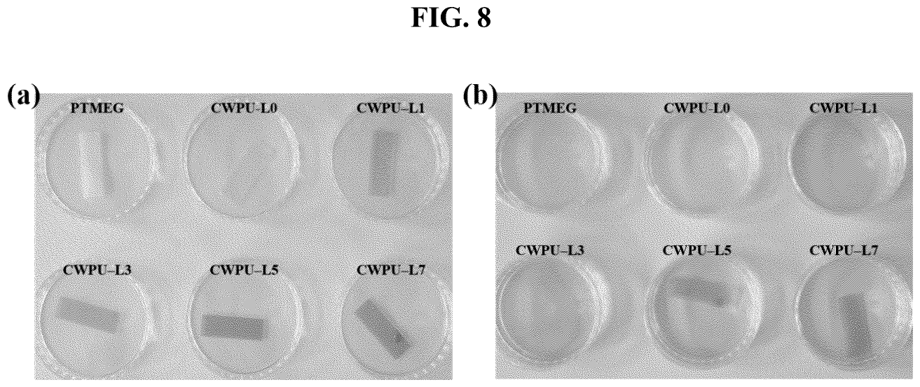

PTMEG and the waterborne polyurethane films produced in Examples 1 to 4 and Comparative Example 1 were immersed in ethanol for 10 hours, and changes thereof were observed. The results are shown in FIG. 8.

As shown in FIG. 8(b), it was confirmed that PTMEG and the CWPU-L0, CWPU-L1 and CWPU-L3 produced in Comparative Example 1 and Examples 3 to 4 were dissolved in ethanol after 10 hours, whereas CWPU-L7 and CWPU-L5 having high lignin contents, produced in Examples 1 and 2, maintained the film shape without dissolving in ethanol.

From the above results, it was confirmed that the biobased waterborne polyurethane containing lignin, produced according to the present disclosure had resistance, did not dissolve in ethanol by exhibiting resistance to ethanol due to the interaction between lignin and polyurethane, and its resistance to ethanol increased as the lignin content increased.

### <Experimental Example 7> Measurement of Mechanical Properties

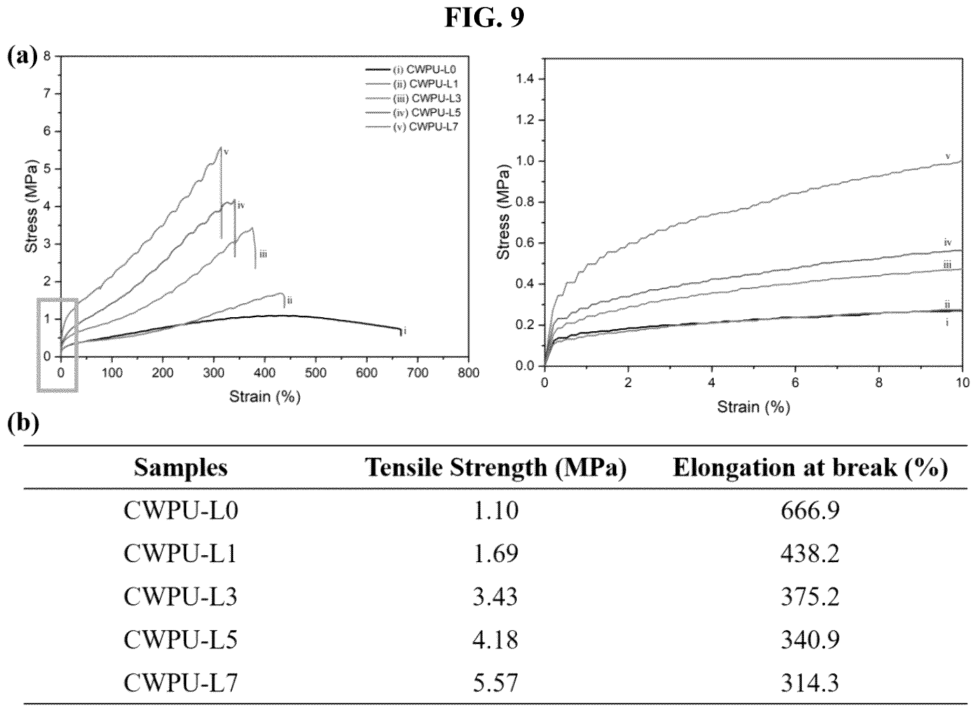

The mechanical properties of the waterborne polyurethane films produced in Examples 1 to 4 and Comparative Example 1 were measured by tensile testing, and the results are shown in FIG. 9.

As shown in FIG. 9(a), it was confirmed that CWPU-L0, CWPU-L1 and CWPU-L3 produced in Comparative Example 1 and Examples 3 and 4 showed breakage at a strain of 300 to 400%, whereas CWPU-L7 and CWPU-L5 having high lignin contents, produced in Examples 1 and 2, showed breakage at strains of 700% and 450%, respectively. In addition, as the lignin content increased, the Young's modulus increased.

In addition, as shown in FIG. 9(b), it was confirmed that as the lignin content increased, the tensile strength increased, but the elongation at break decreased.

From the above results, it was confirmed that the biobased polyurethane containing lignin, produced according to the present disclosure, exhibited improved mechanical properties due to the interaction between lignin and polyurethane.

### <Experimental Example 8> Measurement of UV Protection Properties

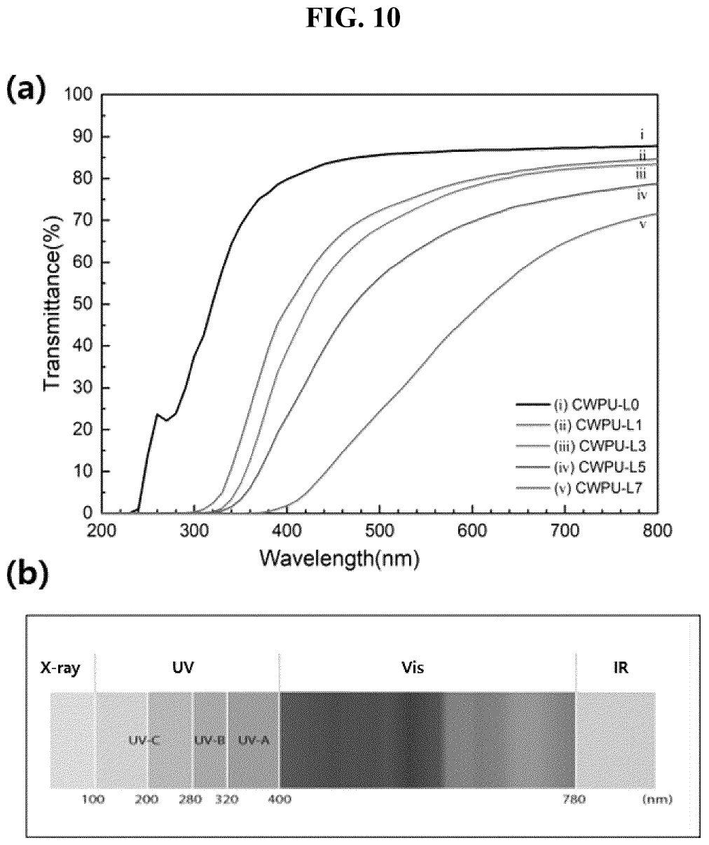

Ultraviolet-visible (UV-Vis) spectrometry was performed on the waterborne polyurethane films produced in Examples 1 to 4 and Comparative Example 1, and the results are shown in FIG. 10.

As shown in FIG. 10, it was confirmed that the UV protection properties of the films increased as the lignin content increased, and that CWPU-L7 produced in Example 1 protected against ultraviolet (UV) rays in the wavelength range of 190 to 390 nm, as well as visible and infrared rays.

From the above results, it was confirmed that the biobased waterborne polyurethane containing lignin, produced according to the present disclosure, exhibited excellent UV protection properties by having high dispersibility due to the interaction between structural features of lignin, such as phenol, ketone and quinoid structures, and biobased waterborne polyurethane molecules.

### <Experimental Example 9> Antibacterial Test

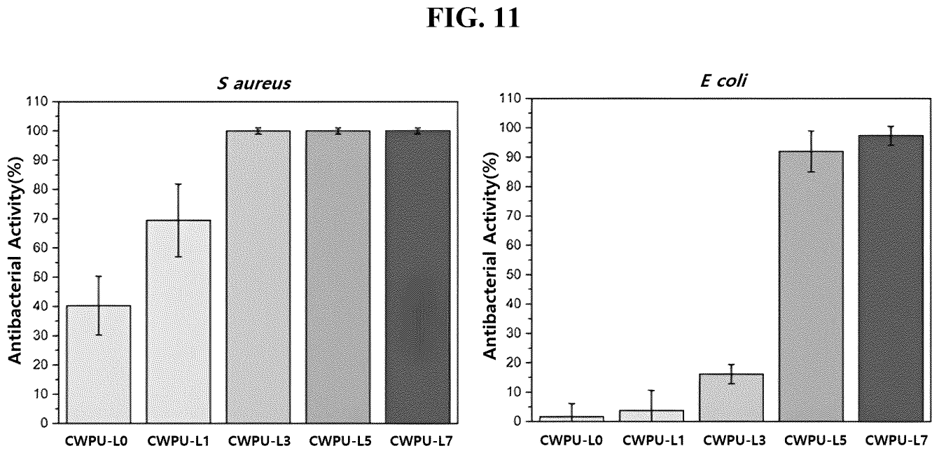

An antibacterial test against Staphylococcus aureus and Escherichia coli was conducted on the waterborne polyurethane films produced in Examples 1 to 4 and Comparative Example 1, and the results are shown in FIG. 11.

As shown in FIG. 11, it was confirmed that CWPU-L0 containing no lignin, produced in in Comparative Example 1, exhibited no antibacterial activity, whereas CWPU-L7, CWPU-L5, CWPU-L3 and CWPU-L1 containing lignin, produced in Examples 1 to 4, exhibited antibacterial activity against Staphylococcus aureus and Escherichia coli, and the antibacterial activity increased as the lignin content increased.

In particular, CWPU-L7, CWPU-L5 and CWPU-L3 exhibited a high antibacterial activity of 99.99% against Staphylococcus aureus.

Also, CWPU-L7 and CWPU-L5 exhibited high antibacterial activities of 97.27% and 91.94%, respectively, against E. coli.

From the above results, it was confirmed that the biobased waterborne polyurethane containing lignin, produced according to the present disclosure, exhibited high antibacterial activity due to the interaction between lignin and polyurethane, and the antibacterial activity increased as the lignin content increased.

What is claimed is:

1. A multifunctional biobased waterborne polyurethane composition comprising, based on 100 parts by weight of the polyurethane composition, 40 to 50 parts by weight of a polyol, 34 to 42 parts by weight of an isocyanate, 8 to 14 parts by weight of a chain extender, 0.03 to 0.12 parts by weight of a catalyst, and 0.005 to 0.02 parts by weight of a neutralizing agent.

2. The multifunctional biobased waterborne polyurethane composition according to claim 1, further comprising 1 to 10 parts by weight of lignin.

3. The multifunctional biobased waterborne polyurethane composition according to claim 1, wherein the isocyanate, the polyol and the chain extender are comprised at a molar ratio of 1:2.3 to 2.7:0.4 to 0.8.

4. The multifunctional biobased waterborne polyurethane composition according to claim 1, wherein
the polyol is any one or more selected from the group consisting of a bio-polyol and a polyol,
wherein the bio-polyol is any one or more selected from the group consisting of castor oil, soybean oil, canola oil, peanut oil, coconut oil, sunflower oil, and cashew nut shell liquid, and
the polyol is any one or more selected from the group consisting of aliphatic polyester polyol, polyether polyol, aromatic polyester polyol, polyethylene glycol, and phenolic polyol.

5. The multifunctional biobased waterborne polyurethane composition according to claim 1, wherein
the isocyanate is any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI),
the chain extender is any one or more selected from the group consisting of N-methyldiethanolamine (MDEA) and diethylamine (DEA),
the catalyst is any one or more selected from the group consisting of dibutyltin dilaurate (DBTDL), dimethyl hydroxy tin oleate, and dibutyltin maleate, and
the neutralizing agent is any one or more selected from the group consisting of acetic acid, formic acid, and propionic acid.

6. A method for producing multifunctional biobased waterborne polyurethane, comprising steps of:
producing a first reaction solution by adding an isocyanate and a first chain extender to a reaction solvent, followed by reaction at 40 to 60° C. for 40 to 80 minutes;
producing a second reaction solution by adding a polyol to the first reaction solution, followed by reaction at a temperature of 55 to 75° C. for 20 to 40 minutes;
producing a third reaction solution by adding a reaction catalyst to the second reaction solution, followed by reaction for 40 to 80 minutes;
producing a fourth reaction solution by adding a second chain extender to the third reaction solution, followed by chain extension reaction for 2 to 4 hours;
cooling the fourth reaction solution to room temperature, followed by neutralization with a neutralizing agent;
adding an aqueous lignin solution to the neutralized solution with stirring;
emulsifying the stirred solution by dispersion for 10 to 14 hours;
evaporating the solvent from the emulsified solution; and
collecting polyurethane as a final product.

7. The method according to claim 6, wherein the step of adding the aqueous lignin solution comprises adding lignin in an amount of 1 to 10 parts by weight based on 100 parts by weight of the polyurethane.

8. The method according to claim 6, wherein, based on 100 parts by weight of the polyurethane, 40 to 50 parts by weight of the polyol, 1 to 10 parts by weight of the lignin, 34 to 42 parts by weight of the isocyanate, 8 to 14 parts by weight of the chain extender, 0.03 to 0.12 parts by weight of the catalyst, and 0.005 to 0.02 parts by weight of the neutralizing agent are added.

9. The method according to claim 6, wherein the isocyanate, the polyol and the chain extender are added at a molar ratio of 1:2.3 to 2.7:0.4 to 0.8.

10. The method according to claim 6, wherein
the polyol is any one or more selected from the group consisting of a bio-polyol and a polyol,
wherein the bio-polyol is any one or more selected from the group consisting of castor oil, soybean oil, canola oil, peanut oil, coconut oil, sunflower oil, and cashew nut shell liquid, and
the polyol is any one or more selected from the group consisting of aliphatic polyester polyol, polyether polyol, aromatic polyester polyol, polyethylene glycol, and phenolic polyol.

11. The method according to claim 6, wherein
the isocyanate is any one or more selected from the group consisting of isophorone diisocyanate (IPDI), methylene diphenyl diisocyanate (MDI), toluene diisocyanate (TDI), methylene bis(4-cyclohyxyl isocyanate (H12MDI), naphthalene diisocyanate (NDI), and hexamethylene diisocyanate (HDI),
the chain extender is any one or more selected from the group consisting of N-methyldiethanolamine (MDEA) and diethylamine (DEA),
the catalyst is any one or more selected from the group consisting of dibutyltin dilaurate (DBTDL), dimethyl hydroxy tin oleate, and dibutyltin maleate, and
the neutralizing agent is any one or more selected from the group consisting of acetic acid, formic acid, and propionic acid.

12. The method according to claim 6, wherein the produced waterborne polyurethane has a glass transition temperature (Tg) of 20 to 35° C.

13. The method according to claim 6, wherein the produced waterborne polyurethane has a full width at half maximum (FWHM) at 20 of 6.58 to 6.85°.

14. The method according to claim 6, wherein the produced waterborne polyurethane has resistance to ethanol.
